(19) United States
(12) Patent Application Publication
(10) Pub. No.: US 2011/0123835 A1
(43) Pub. Date: May 26, 2011

(54) METHANE-POWERED MICROBIAL FUEL CELLS

(75) Inventors: Peter Girguis, Medford, MA (US); Clare E. Reimers, Philomath, OR (US)

(73) Assignees: President and Fellows of Harvard College; The State of Oregon Acting by and through the State Board of Higher Edu. on Behalf of Oregon S.U

(21) Appl. No.: 12/994,598

(22) PCT Filed: May 27, 2009
(86) PCT No.: PCT/US2009/003209

§ 371 Date: Jan. 7, 2011

Related U.S. Application Data
(60) Provisional application No. 61/056,764, filed on May 28, 2008.
(60) Provisional application No. 61/113,704, filed on Nov. 12, 2008.

(51) Int. Cl. H01M 8/16

(52) U.S. Cl. 429/2

(57) ABSTRACT

The present disclosure generally relates to fuel cells and, in particular, to microbial fuel cells. In one aspect, the fuel cell can use microorganisms (microbes) to oxidize fuel, especially methane. For instance, the fuel cell may use one or more types of methanotrophs, such as Methylomonas methanica. The methanotroph may be anaerobic and/or aerobic, and the fuel cell may be open (e.g., to the atmosphere) or sealed. In some cases, a population of methanotrophs is used. In some cases, syntrophic associations may be formed between different species of microorganisms. In one embodiment, the fuel cell is of a columnar design, e.g., a packed bead column. Other inventive aspects relate to techniques for forming such fuel cells and fuel cell components, techniques for using such fuel cells, systems involving such fuel cells, and the like.

### RELATED APPLICATIONS

This application claims the benefit of U.S. Provisional Patent Application Ser. No. 61/056,764, filed May 28, 2008, entitled “Methane-Powered Microbial Fuel Cells,” by P. Girguis; and U.S. Provisional Patent Application Ser. No. 61/113,704, filed Nov. 12, 2008, entitled “Methane-Powered Microbial Fuel Cells,” by P. Girguis. Each of the above is incorporated herein by reference.

### GOVERNMENT FUNDING

This invention was made with government support under HR0011-04-1-0023 awarded by the U.S. Department of Defense/DARPA. The U.S. government has certain rights in the invention.

### FIELD OF INVENTION

The present disclosure generally relates to fuel cells and, in particular, to microbial fuel cells.

### BACKGROUND

Microbial fuel cells are devices that generate electricity by harnessing the power of microbial metabolism. To date, microbial fuel cells have been tested and shown to produce power in a variety of environments, including laboratory cultures, sewage treatment plants, and terrestrial and marine sediments. Almost all of these prior systems produce comparable power, typically producing between 30 mW/m² and 150 mW/m² of electrode surface continuously (i.e., when operated under constant load). In nearly all these systems, the potential between the anode and the cathode is 100 mV to 700 mV. This is attributable to the chemical condition used in these microbial fuel cells, usually an oxygen-rich cathode environment and an organic-rich anode environment. Investigators have typically focused on increasing current by increasing the available organic carbon, by stimulating the production of natural electron mediators to help shuttle electrons between the microbes and the anode, by retaining heat generated as a byproduct of catabolism, or by circulating fluids around the anode and cathode to increase substrate availability. Improvements in microbial fuel cell design are needed.

### SUMMARY OF THE INVENTION

The present disclosure generally relates to fuel cells and, in particular, to microbial fuel cells. The subject matter of the present invention involves, in some cases, interrelated products, alternative solutions to a particular problem, and/or a plurality of different uses of one or more systems and/or articles.

In one aspect, the invention is directed to an article. The article, in one set of embodiments, is generally directed to a fuel cell comprising a first compartment containing an anode and a second compartment containing a cathode. In some cases, the first compartment further can contains methanotrophs able to oxidize methane delivered to the fuel cell to produce electrons that can be accepted by the anode.

The article, in another set of embodiments, is generally directed to a fuel cell comprising sediment. In one embodiment, the sediment contains methanotrophs. According to another set of embodiments, the article includes a fuel cell comprising microorganisms able to oxidize methane to produce power.

The invention, in another aspect, is directed to a method. In one set of embodiments, the method includes acts of providing a fuel cell containing sediment, passing water containing methane through the sediment, wherein the sediment contains methanotrophs able to oxidize the methane in the water, and collecting current from the fuel cell produced by oxidation of methane by the methanotrophs in the sediment. In another set of embodiments, the method includes acts of providing a fuel cell containing a first comportment containing methanotrophs able to oxidize methane delivered to the fuel cell, passing water containing methane through the first compartment, and collecting current from the fuel cell produced by oxidation of methane by the methanotrophs.

In one aspect, the present invention is directed to a method of making one or more of the embodiments described herein, for example, a fuel cell. In another aspect, the present invention is directed to a method of using one or more of the embodiments described herein, for example, a fuel cell.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B illustrate the power density of a device produced according to one embodiment of the invention;

FIG. 2 shows a reactor according to another embodiment of the invention;

FIGS. 3A-3B illustrate oxidation potentials of various species, in another embodiment of the invention;

FIGS. 4A-4B illustrate a reactor in yet another embodiment of the invention;

FIGS. 5A-5C illustrate power densities of various species, in still another embodiment of the invention;

FIGS. 6A-6B illustrate syntrophic coupling between ANME-3 and a bacteria, desulfobulbus proprionicus, in one embodiment of the invention;

FIG. 7 illustrate various chemical reactions for methane oxidation, in various embodiments of the invention;

FIG. 8 illustrate a schematic of reactor, in another embodiment of the invention; and

FIG. 9 illustrates a phylogenetic tree of archaea, in accordance with still another embodiment of the invention.

### DETAILED DESCRIPTION

The present disclosure generally relates to fuel cells and, in particular, to microbial fuel cells. In one aspect, the fuel cell can use microorganisms (microbes) to oxidize fuel, especially methane. For instance, the fuel cell may use one or more types of methanotrophs, such as Methylomonas methanica. The methanotrophs may be anaerobic and/or aerobic, and the fuel cell may be open (e.g., to the atmosphere) or sealed. In some cases, a population of methanotrophs is used. In some cases, syntrophic associations may be formed between different species of microorganisms. In one embodiment, the fuel cell is of a columnar design, e.g., a packed bead column. Other inventive aspects relate to techniques for forming such fuel cells and fuel cell components, techniques for using such fuel cells, systems involving such fuel cells, and the like.

The following documents are incorporated herein by reference: International Patent Application No. PCT/US2007/020357, filed Sep. 20, 2007, entitled “Methods and Apparatus for Stimulating and Managing Power from Microbial Fuel Cells,” by Girguis, et al., published as WO 2008/036347 on Mar. 27, 2008; U.S. Provisional Patent Application Ser. No. 60/845,921, filed Aug. 20, 2006, entitled “High-performance Thermophilic Microbial Fuel Cell,” by Girguis, et al.; U.S. Provisional Patent Application Ser. No. 60/914,025, filed Apr. 25, 2007, entitled “Methods and Apparatus for Providing Power from Microbial Fuel Cells,” by Girguis, et al.; and U.S. Provisional Patent Application Ser. No. 60/914,108, filed Apr. 26, 2007, entitled “Methods and Apparatus for Stimulating and Managing Power from Microbial Fuel Cells,” by Girguis, et al., Also incorporated herein by reference are U.S. Provisional Patent Application Ser. No. 61/056,764, filed May 28, 2008, entitled “Methane-Powered Microbial Fuel Cells,” by P. Girguis; and U.S. Provisional Patent Application Ser. No. 61/113,704, filed Nov. 12, 2008, entitled “Methane-Powered Microbial Fuel Cells,” by P. Girguis.

Various aspects of the disclosure are generally directed to a fuel cell or other electrochemical devices that use similar operating principles, for example, other electrochemical devices that are able to oxidize fuel to produce electrons. A fuel cell is a device that converts fuel to electrical energy without combustion of the fuel (although a fuel cell could be used in conjunction with a device deriving energy from combustion of the same fuel; most fuel cells do not). A typical fuel cell includes two electrodes, an anode and a cathode, an electrolyte in contact with both the anode and cathode, and an electrical circuit connecting the anode and the cathode from which power created by the fuel cell can be drawn. The anode and the cathode are typically contained within separate compartments, which may be separated by an interface or a barrier.

In one set of embodiments, the barrier may be formed from a metal, such as gold, palladium, or platinum, and in some cases, the barrier may be backed on one or both sides by an inert film, for instance, comprising a hydrophobic polymer such as polytetrafluoroethylene (Teflon). Such a barrier may be used, in some cases, to allow the exchange of hydrogen gas and/or ions, but generally impede the exchange of other dissolved gases.

In some cases, the fuel cell may contain a plurality of anodes and/or cathodes, e.g., in the same or different compartments, which may be operated in series and/or in parallel.

In some cases, the fuel cell may include one or more electrodes that are encased in an ion-permeable film, e.g., one that allows solute exchange but prohibits or inhibits microbes from leaving the surface of the electrode (and/or prohibits microbes in the media from colonizing the surface of the electrode). For example, the membrane may be composed of a film that would effectively limit or inhibit the mixing of microbes (including viruses and phage) but allow the exchange of dissolved ions. This membrane may be made of various materials, including but not limited to dialysis film, regenerated cellulose, tetrafluoroethylene (Teflon), or the like.

In typical operation, an oxidant (e.g., oxygen, such as the oxygen found in the air) is provided to a cathode of a fuel cell where it is reduced, e.g., to form water, while a fuel (e.g., methane) in the anode is oxidized, e.g., to produce CO₂, H⁺, and/or electrons. The electrons may be removed from the anode by a current collector, or other component of an electrical circuit, which results in an electrical current. The overall reaction may be energetically favorable, i.e., the reaction gives up energy in the form of energy or power driving electrons from the anode, through electrical circuitry, to the cathode. This energy can be captured for essentially any purpose, e.g., for immediate use and/or for storage for later use.

The fuel cell may be fabricated from any suitable material. For example, in one set of embodiments, the fuel cell, or a portion thereof, such as an anode compartment, may be fabricated from non-conductive materials, for instance, from any polymer such as polyvinyl chloride, polyethylene, polypropylene, or polyethylene terephthalate. In another set of embodiments, the fuel cell (or portion thereof) may be formed from thermally insulative and/or non-conductive materials such as ceramics, glass, wood, and/or metals that may or may not be coated with thermal or electrical insulators, e.g. Teflon-coated aluminum, polymeric-coated steel, glass-lined stainless steel, etc. As discussed in detail below, in some embodiments of the disclosure, thermal insulators are useful for the management or retention of heat within the fuel cell, which may lead to higher microbial metabolism or efficiency, and/or higher power output.

In some aspects of the disclosure, the fuel cell is a microbial fuel cell (or “MFC”), i.e., the fuel cell uses microorganisms to converts fuel to electrical energy without combustion of the fuel, typically via an oxidation process. In one set of embodiments, the microbial fuel cell contains an anode and a cathode, each within different compartments. The cathode may be placed in a compartment with an abundance of oxygen (i.e. an aerobic environment), and/or in the presence of a soluble oxidant such as nitrate, sulfate, iron oxide, or manganese oxide, while the anode may be placed in a second compartment having an environment that is deficient in oxygen (i.e., an anaerobic environment), and/or other oxidants including, but not limited to, soluble oxidants such as nitrate, sulfate, iron oxide, manganese oxide, etc. In one embodiment, the anode contains a percentage of oxygen that is less than atmospheric oxygen, i.e., less than about 21% by total volume. For example, oxygen may be present in the second compartment at a percentage of less than about 18%, less than about 15%, or less than about 10% by volume. In another embodiment, the anode does not contain sufficient oxygen to completely oxidize any fuel present within the anode compartment, e.g., enough oxygen to stoichiometrically combust the fuel within the anode compartment to form fully oxidized species such as CO₂, H₂O, NO₂, SO₂, etc. For instance, the anode compartment may contain less than the stoichiometric amount of oxygen needed to oxidize the available fuel. Typically, the fuel in a microbial fuel cell is a carbon-containing fuel, and is often organically based. In one embodiment, the fuel is methane.

If methane is used, the methane may be produced from materials such as chemical or industrial reactions, or biomass, i.e., matter derived from living biological organisms. “Biomass,” as used herein, may arise from plants or animals. For example, plants such as switchgrass, hemp, corn, poplar, willow, or sugarcane may be used as a fuel source in a fuel cell of the present disclosure. The entire plant, or a portion of a plant, may be used as the fuel source, depending on the type of plant. As another example, biomass may be derived from animals, for instance, animal waste or animal feces, including human sewage (which may be used raw, or after some treatment). Still other non-limiting examples of biomass include food scraps, lawn and garden clippings, dog feces, bird feces, composted livestock waste, untreated poultry waste, etc. The biomass need not be precisely defined. In some cases, the biomass does not necessarily exclude fossil fuels such as oil, petroleum, coal, etc., which are not derived from recently living biological organisms, nor does it exclude refined or processed materials such as kerosene or gasoline. For example, biomass used as fuel in various fuel cells of the present disclosure may be derived from a compost pile, a manure pile, a septic tank, a sewage treatment facility, etc., and/or from naturally organic-rich environments such as estuaries, peat bogs, methane bogs, riverbeds, plant litter, etc.

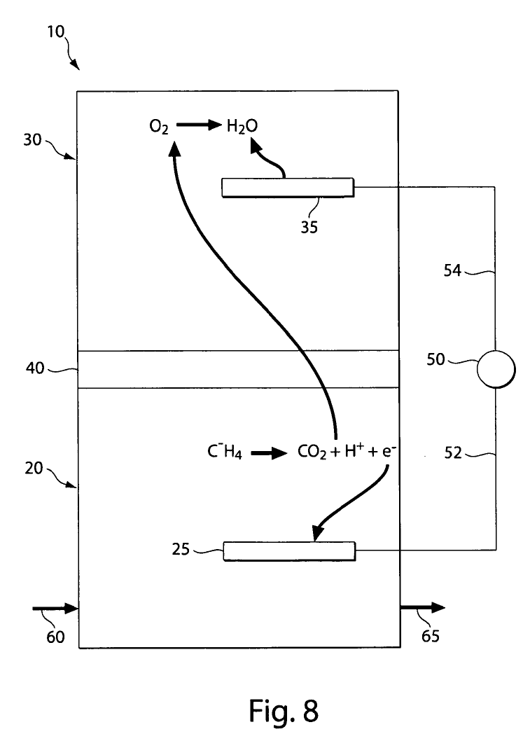

A schematic view of one fuel cell of the disclosure is shown in FIG. 8. In this example, fuel cell 10 comprises anode compartment 20 and cathode compartment 30, separated by interface 40. Within anode compartment 20 is anode 25, and within cathode compartment 30 is cathode 35. Electrical connections 52 and 54 from each of these respective electrodes are then connected to load 50, e.g. a light, a motor, an energy storage device, a switching circuit, or the like. The potential between anode 25 and cathode 35 results in net electron flow towards the cathode 35 and through the load. Charge balance and continuity can be maintained by proton diffusion and/or transport from cathode compartment 30 to anode compartment 20. Anode compartment 20 may contain microorganisms able to directly oxidize methane or other carbon-containing fuels to produce hydrogen and/or electrons (represented schematically as CH₄-->CO₂+H⁺+e⁻). In some cases, anode compartment 20 is an anaerobic environment deficient in oxygen gas (O₂) or other dissolved oxidants such as nitrate or sulfate, and electrons produced during oxidation of fuel by the microorganisms are not passed to oxygen or other endogenous oxidants, as a terminal electron acceptor (e.g., to produce H₂O), but instead can be collected by anode 25 as electricity. In some cases, at least about 5% of the electrons accepted by the anode are produced by the microorganisms, and in some cases, at least about 10%, at least about 25%, at least about 50%, at least about 75%, or at least about 100% of the electrons accepted by the anode are produced by the microorganisms.

The fuel may be present within the anode compartment before the fuel cell is used to produce electricity (a “closed” fuel cell), or added during operation of the fuel cell to produce electricity (an “open” fuel cell).

Hydrogen produced during oxidation of the methane may be transported across interface 40 from anode compartment 20, where the hydrogen is produced, to cathode compartment 30. In some cases, interface 40 is a proton exchange interface that allows hydrogen to be transported across, but does not allow substantial transport of other dissolved compounds to occur, e.g., the interface may limit the diffusion of reduced or oxidized chemical compounds between the anode compartment 20 and the cathode compartment 30 that can have a deleterious effect on fuel cell performance. In some cases, the proton exchange barrier may prevent or at least inhibit oxygen gas from diffusing into the anode compartment, while allowing hydrogen to move between the compartments, thereby causing the anode compartment to become anaerobic (deficient in oxygen) during operation of the fuel cell. In one embodiment, the proton exchange barrier includes a synthetic polymer membrane that separates the two compartments. In other embodiments, however, the proton exchange interface may contain particles (e.g., of sand), for instance, forming a particulate bed, optionally held by mesh filters, such as those discussed below.

Within cathode compartment 30, hydrogen from anode compartment 20 may enter from interface 40 to be oxidized to form water, e.g., by being combined with electrons from cathode 35 (thereby completing the electrical circuit with anode compartment 30) and O₂, e.g., from the air, i.e., O₂+H⁺+e⁻-->H₂O. Cathode compartment 30 may thus contain an aerobic environment, and in some cases, cathode 30 is open to the atmosphere and/or is in fluidic communication with the atmosphere, e.g., through one or more conduits. In some embodiments, hydrogen may also be captured (e.g., via diffusion) into a gas collector overlying cathode compartment 30.

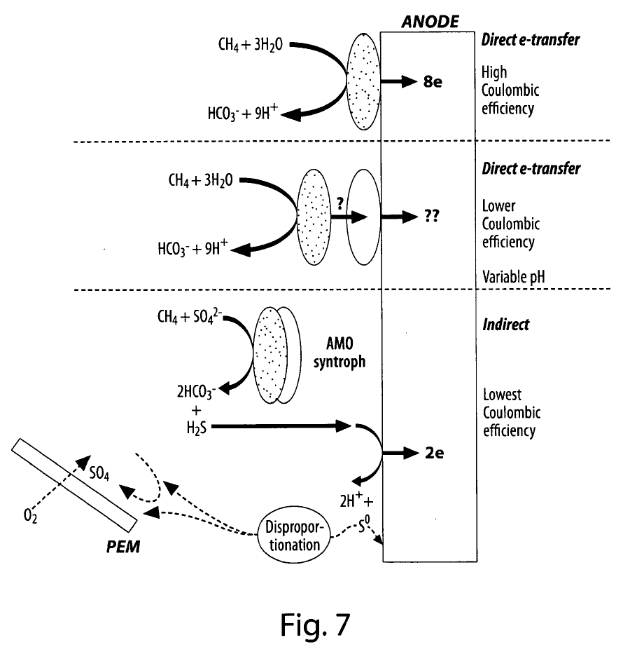

It should be noted that the chemical reactions shown in FIG. 10 are for illustrative purposes only, and are not stoichiometrically balanced; the actual reactions, of course, will depend on factors such as the type of fuel used, the operating temperature, the types of microorganisms involved, and the like. In some cases, the actual reaction may not be well-characterized. Examples of possible reactions occurring within the anode compartment include those shown in FIG. 7. As another example, as discussed below, in some embodiments of the disclosure, microorganisms may be used within the fuel cell that are able to transfer electrons to any suitable non-oxygen species, such as a metal, a mineral, ammonia, a nitrate, etc.

Microorganisms present within one or both compartments may be able to grow on the respective electrodes. For example, microorganisms in anode compartment 20 (which may be run in an anaerobic condition) may metabolize methane or other carbon-containing fuels and transfer electrons produced during this process to the anode 25. Because of the difference in electrical potential between the anode compartment and the cathode compartment, the electrons move towards cathode 35 through load 50. The microorganisms within the anode compartment thus are able to utilize the anode as a terminal electron acceptor, thereby producing electrical current. In some cases, the potential created between the anode compartment and the cathode compartment may be between about 0.1 V and about 1 V, or between about 0.2 V and about 0.7 V.

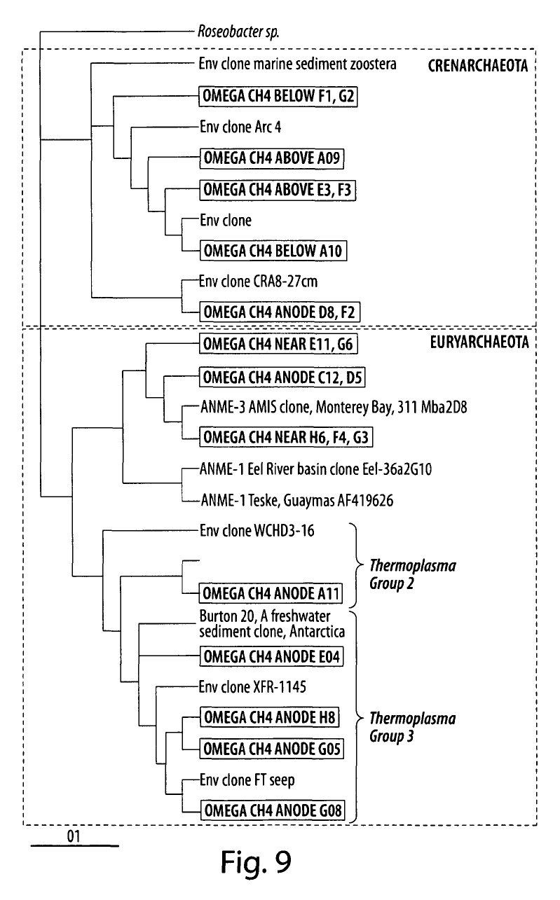

As mentioned, various embodiments of the disclosure use microorganisms able to oxidize fuel to produce electricity. Such microorganisms may be aerobic and/or anaerobic, and may include bacteria, fungi, archaea, protists, etc. In one embodiment, the microorganisms are methanotrophs, i.e., the microorganisms are able to metabolize methane, e.g., as a carbon source. Examples of methanotrophs include, but are not limited to, Methylomonas methanica, or other microorganisms such as is shown in FIG. 9. For example, the methanotrophs may include various species of bacteria, fungi, microeukaryotes, Crenarchaeota or Euryarchaeota.

Typically the microorganisms are unicellular, although in some cases, the microorganisms may include multicellular lower organisms. The microorganisms are usually, but not always, of microscopic dimensions, i.e., being too small to be seen by the human eye.

The microorganisms used in the fuel cell may be a monoculture, or in some cases, a diverse culture or population of phylotypes. The term “phylotype,” as used herein, is used to describe an organism whose genetic sequence differs from known species by less than approximately 2% or less than approximately 1% of its base pairs. For example, the microorganisms contained within a fuel cell that are able to oxidize a fuel to produce electricity may comprise at least 10 phylotypes, at least 30 phylotypes, at least 100 phylotypes, at least 300 phylotypes, at least 1,000 phylotypes, etc. of various microorganisms, which may not all necessarily be fully characterized for operation of the fuel cell. The microorganisms may be naturally occurring, genetically engineered, and/or selected via natural selection processes. For example, in one embodiment, a population of microorganisms used as an inoculum in a fuel cell of the disclosure may be taken from another microbial fuel cell, which may also be a microbial fuel cell of the disclosure; repetition of this process may result in natural selection of a population of microorganisms having desirable characteristics, such as the ability to rapidly oxidize specific types of fuel.

The microorganisms may be used to directly oxidize methane to produce electricity in various embodiments of the disclosure, i.e., the microorganisms that oxidize the methane in the fuel cell produce electrons during the oxidation process, which are then directly collected (e.g., by an anode) to produce electricity. Accordingly, in one embodiment, the present disclosure discloses a fuel cell that uses one or more microorganisms (for instance, naturally occurring and/or genetically engineered phylotypes, etc.) to directly oxidize methane or other carbon-containing fuels to produce electricity, for instance, in a that results in high net efficiency of power production per unit fuel oxidized. In some cases, the microorganisms may be a community of microorganisms, and in certain instances, not all of the community of microorganisms need be individually determined.

In some cases, the microorganism population within a fuel cell of the present disclosure is one that is not well-defined or characterized. In contrast, many prior art microbial fuel cells rely on a key microorganism species for operation. In some embodiments, there may be a population of various microorganisms contained within the fuel cell that are able to oxidize a methane or other carbon-containing fuels to produce electricity, and the species of microorganisms forming such populations need not be explicitly identified or characterized. There may be at least 10 species, at least 30 species, at least 100 species, at least 300 species, at least 1,000 species, etc. of various microorganisms within a fuel cell of the present disclosure that are able to, in whole or in part, directly oxidize methane or other carbon-containing fuels to produce electricity. For instance, in some cases, two or more species of microorganisms together define a reaction pathway where methane or other carbon-containing fuels is oxidized to produce electricity. As mentioned, the microorganisms may be naturally occurring, genetically engineered, and/or selected via natural selection processes.

As a specific, non-limiting example, the microorganism population may be one that arises from a sample of soil, and may be used in the fuel cell, e.g., as an inoculum, without identifying or characterizing the population of microorganisms. Thus, for example, prior to operation of a fuel cell of the present disclosure, an inoculum of soil may be added, e.g., to an anode compartment. Any soil sample may be used, and the soil sample may be used without refinement or alteration in some cases. For instance, the soil sample may be one from any depth of soil (e.g., surface soil, or from subsoil regions, e.g., from at least 3 inches deep, at least 6 inches deep, at least 9 inches, at least 1 foot, etc.), and may be taken from any suitable location, for example, from Massachusetts or California, or any other suitable geographic locale.

In some cases, the population of microorganisms (even if not well-characterized), may change during operation of the fuel cell. For example, the population of the microorganisms and/or their relative ratios may change, for instance, due to factors such as the type of fuel being delivered to the fuel cell, the operating temperature of the fuel cell, the oxygen concentration within the fuel cell, the various rates of growth of the microorganisms, growth factors in the environment surrounding the microorganisms, etc. In some cases, the microorganisms may be brought to the fuel cell with the biomass. As an example, biomass such as sewage, compost, manure, or the like may contain suitable microorganisms for operation of a fuel cell of the present disclosure.

In one set of embodiments, at least some of the microorganisms within the fuel cell able to oxidize methane or other carbon-containing fuels to produce electricity are anaerobic (although in other embodiments, at least some of the microorganisms are aerobic), i.e., the microorganisms do not require oxygen for growth, although the microorganisms, in some cases, can tolerate the presence of oxygen (aerotolerant), or even use oxygen for growth, when oxygen is present (facultative anaerobes). Those of ordinary skill in the art will be able to identify a microorganism as an aerobe or an anaerobe, e.g., by culturing the microorganism in the presence and in the absence of oxygen (or in a reduced concentration of ambient oxygen). Such anaerobic microorganisms are often found in lower regions of soil (where there is a reduced amount of oxygen present), and generally are able to oxidize or metabolize a fuel in without using oxygen as a terminal electron acceptor. A terminal electron acceptor is generally a chemical species, such as oxygen (O₂), that is reduced upon acceptance of electrons to produce a species that is not further reduced by acceptance of electrons; for instance, O₂ may be reduced to form H₂O.

As specific examples, a microorganism may be able to transfer electrons to a non-oxygen (O₂) species that is able to act as a terminal electron acceptor. For instance, the terminal electron acceptor may be a metal such as iron or manganese, ammonia, a nitrate, a nitrite, sulfur, a sulfate, a selenate, an arsenate, or the like. Note that the terminal electron acceptor may comprise bound oxygen in some cases (for example, as in a nitrate or a nitrite) but the terminal electron acceptor is not oxygen, i.e., O₂. As discussed below, in certain embodiments of the present disclosure, an electrode may function as a terminal electron acceptor, and the electrons collected by the electrode may be collected as electricity. In some cases, the electrode may contain an oxidizable and/or a conductive species, which may facilitate electron collection.

In one embodiment, as s a specific non-limiting example, a sulfate may be reduced to a sulfide, and the sulfide may, in some cases, be deposited on an anode as elemental sulfur. This could be used, for instance, to reduce the total dissolved sulfur species in the system. Thus, in some cases, the fuel cell may be use to remove sulfur from the liquid and/or gaseous phases.

In some cases, the methanotrophs are present on biological sediment, e.g., sediment from a body of water, such as a lake or an ocean. Without wishing to be bound by any theory, it is believed that the sediments contain microorganisms in a substantially anaerobic environment that are able to utilize methane and other carbon sources as fuel. Accordingly, in one set of embodiments, the fuel cell contains sediments that may contain one or more methanotrophs. As discussed in some cases, the methanotrophs may not be well-characterized, and/or the population of methanotrophs may change over time, e.g., during usage of the fuel cell. For instance, in one set of embodiments, synergistic or syntrophic associations may be formed between various microorganisms in culture, which may include methanotrophs and/or other organisms. An example of such an association is discussed below.

The fuel for the fuel cell may comprise methane. The methane may be delivered in any suitable form. For instance, the methane may be delivered as a gas, either in pure form or with other components present, e.g., oxygen, nitrogen, air, hydrogen, CO, CO₂, NOₓ, SOₓ, or the like. As a non-limiting example, oxygen may be present if at least some of the methanotrophs are aerobic. In some cases, the methane may be present dissolved in a liquid such as water, e.g., seawater.

The microorganisms may oxidize the methane to produce CO₂ and/or hydrogen (e.g., as protons and/or hydrogen gas), releasing electrons in the process. In some embodiments, the recipient of these electrons (or the terminal electron acceptor) is a component of an electrode, i.e., electrons produced by the microorganism during oxidation of methane are expelled from the interior of the cell to an electrode, either directly or indirectly, which are then harnessed, e.g., for power. For example, an anaerobic microorganism may oxidize methane to form CO₂ and/or other species (e.g., fully oxidized species, such as H₂O, NO₂, SO₂, etc.), releasing electrons during the oxidation process, which are then reacted with the terminal electron acceptor. In some cases, the terminal electron acceptor may be present on the electrode, e.g., to facilitate collection of the electrons into an electrical circuit.

Additionally, relatively high power outputs may be produced by a fuel cell of the present disclosure in some cases. For example, the fuel cell is able to produce power of at least about 1 W/m² of electrode surface, at least about 1.6 W/m² of electrode surface, at least about 2.7 W/m² of electrode surface, or at least about 4.3 W/m² of electrode surface, etc. In some embodiments, the fuel cell may be heated, for example, internally or externally of the compartment containing the microorganisms. However, in some cases, there may be no active heating of the fuel cell, i.e., the fuel cell is constructed and arranged to passively control its operating temperature. Instead, as the microorganisms may produce heat during oxidation of the fuel, such heat may be retained to heat the compartment containing the microorganisms. In yet other embodiments, a combination of active and passive heating may be used.

In one aspect of the disclosure, microorganism growth within a fuel cell of the present disclosure may be enhanced by the addition of suitable growth agents, such as fertilizer or other nitrogen sources, to the fuel cell. The growth agent may be added to the fuel cell at any suitable time, for example, sequentially and/or simultaneously with the addition of fuel to the fuel cell. The growth agent may be any species able to increase metabolism of a fuel by the microorganisms during operation of the fuel cell, relative to their growth in the absence of the species, and the growth agent may include one, or a plurality, of compounds. The growth agent need not be precisely defined. For example, in some cases, the growth agent may be derived from biomass, for example, animal waste or animal manure (e.g., horse manure, poultry, etc).

As an example, in one set of embodiments, agricultural fertilizer is added to the fuel cell. The fertilizer may contain elements such as nitrogen, phosphorous, and/or potassium (in any suitable compound), which may promote microbial growth. Other examples of elements that may be contained within the fertilizer include, but are not limited to, calcium, sulfur, magnesium, boron, chlorine, manganese, iron, zinc, copper, molybdenum, or the like. In some cases, the fertilizer is a commercially available fertilizer. For example, the fertilizer used in the fuel cell may be plant fertilizer, which is often having a “grade” that describes the percentage amounts of nitrogen, phosphorous, and potassium that is present within the fertilizer. For instance, a fertilizer may have a grade of at least 3-3-2, i.e., comprising at least 3% nitrogen, at least 3% phosphorous, and at least 2% potassium. In one embodiment, the fertilizer comprises substantially equal parts of nitrogen, phosphorous, and potassium. However, the fertilizer is not required to have all three of nitrogen, phosphorous, and potassium.

As another example of a growth agent, a nitrogen source, such as ammonia, a nitrate (e.g., sodium nitrate, potassium nitrate, etc.), or a nitrite (e.g., sodium nitrite, potassium nitrite, etc.) may be passed into the fuel cell as a growth agent, where the nitrogen source is any source of nitrogen that can be metabolized by microorganisms contained within the fuel cell. Nitrogen itself (i.e., N₂) may be a nitrogen source, if the microorganisms are anaerobic and contain the appropriate pathways and enzymes (e.g., using nitrogenases) in sufficient quantities for the nitrogen to be useful as a growth agent. In some embodiments, as mentioned, a fertilizer may include a nitrogen source. In another embodiment, one or more free amino acids are passed into the fuel cell. Examples of amino acids that may be provided to the fuel cell include, but are not limited to, isoleucine, leucine, lysine, methionine, phenylalanine, threonine, tryptophan, and valine, arginine, cysteine, glycine, glutamine, or tyrosine. Such free amino acids may also be nitrogen sources.

Other materials may also be passed into the fuel cell, e.g. as growth agents, or to control conditions within the fuel cell, for instance, to create conditions conducive for microorganism oxidation of a fuel to occur. For example, electrically conductive substrates may be supplied, e.g., to enhance electrical conduction between the microorganisms and the electrodes, or species able to control pH, e.g., alkaline agents and/or acidification agents, may be supplied. Non-limiting examples of these include, but are not limited to, charcoal (e.g., activated charcoal) or lime.

Combinations of these and/or other materials are also contemplated. For example, in one embodiment, 1 part fuel having nearly equal parts nitrogen, phosphorous and potassium, 0.1 part of an alkaline agent such as lime, and 0.1 part of a electrically conductive substance such as activated charcoal may be used in a fuel cell of the present disclosure.

In some cases, the introduction of growth agent or other materials, such as species able to control pH, may be regulated using a control system. For example, the temperature, pH, electrical output, etc. of a fuel cell of the present disclosure may be determined, using suitable sensors, and used to control the introduction of such materials into the fuel cell. For instance, the pH of the anode compartment may be measured, and if too low, an alkaline agent such as lime may be added to the anode compartment.

Another aspect of the disclosure is generally directed to an interface separating an anode compartment and a cathode compartment in a fuel cell. In one set of embodiments, the interface is a proton exchange interface, i.e., the interface allows protons and/or gases (e.g., H₂) to pass through, but does not substantially allow other chemical compounds to pass through, i.e., the proton exchange barrier is an insulator, and/or has a relatively high electrical resistance. For instance, the interface may be formed from materials having a resistivity of at least about 10¹ ohm m (Ωm), at least about 10³ ohm m, at least about 10⁵ ohm m, at least about 10⁸ ohm m, at least about 10¹⁰ ohm m, at least about 10¹¹ ohm m, at least about 10¹² ohm m, at least about 10¹³ ohm m, at least about 10¹⁴ ohm m, etc. Accordingly, the proton exchange barrier allows gases (e.g., produced by microorganisms oxidizing a fuel) to pass therethrough, while electrons are collected by the electrodes and stored or used to perform work.

In some cases, the interface is a polymeric membrane. Examples of suitable proton exchange membranes include, but are not limited to, ionomeric polymers or polymeric electrolytes. For example, in one embodiment, the membrane comprises nafion. Those of ordinary skill in the art will be familiar with proton exchange membranes, such as those used in proton exchange membrane fuel cells. However, in other embodiments, the proton exchange interface may be nonpolymeric.

Still another aspect of the disclosure is directed to electrodes useful in fuel cells, for example, fuel cells that can use microorganisms to oxidize fuel. The electrodes may be designed to have relatively large surface areas, for example, the electrodes may be porous or comprise wires or a mesh, or a plurality of wires or meshes. In certain embodiments, multiple layers of such materials may be used. In some cases, the electrode may also be gas permeable, e.g., to avoid trapping gases such as H₂ or CO₂. In some embodiments, an electrode may include a terminal electron acceptor, and electrons collected by the electrode when a fuel is oxidized by microorganisms in the fuel cell may be collected as electricity. In some cases, the electrode may contain a conductive species, such as graphite, which may facilitate electron collection.

In one set of embodiments, the electrode is flexible and/or does not have a predefined shape. For example, an electrode may include cloth or a fabric, which may be conductive in some cases. Such electrodes may be useful, for instance, in embodiments where a currently existing system, such as a septic tank or a sewage treatment plant, is converted for use as a fuel cell. Such electrodes may also be useful, in certain cases, to increase the effective reactive surface area without increasing the weight or cost. Further, in some cases, such electrodes may be useful in increasing the amount of electrode surface area available for reaction within a compartment of a fuel cell. Examples of flexible materials suitable for use in flexible electrodes includes, but are not limited to, graphite cloth, carbon fiber cloth, carbon fiber impregnated cloth, graphite paper, etc.

In another set of embodiments, the electrode may be formed of and/or include a non-conductive material, and a conductive coating at least partially surrounding the non-conductive material. For instance, the conductive coating may be graphite, such as a graphite-containing paint or a graphite-containing spray, which may be painted or sprayed on, respectively. The non-conductive material may be a ceramic, or a non-conducting polymer, such as polyvinyl chloride or glass. In one embodiment, the non-conductive material is the housing of the compartment itself that contains the electrode. Thus, for example, an electrode of the device may be painted on, sprayed on, or otherwise applied to a wall of the compartment. In other embodiments, however, the electrode may include a conductive material, optionally surrounded by a conductive coating. For instance, the electrode may include a metal, such as aluminum or lead.

Thus, for example, the electrodes may be formed using conductive coatings or paints. For instance, a suspension of about 10% to about 60% graphite, or about 20% to about 60% graphite in a volatile solvent (e.g., methyl ethyl ketone) with an adhesive (e.g., a fluoroelastomer) may used as a graphite paint, and use to paint a non-conductive material such as a metal, a non-conductive polymer, or a ceramic. Graphite paints are readily available commercially, and in some cases, the paint may be supplemented with additional graphite to increase its density. In some cases, a wire may be added to the surface prior to coating, and connected to an electrical load, such as those described herein. In some cases, the wire can be potted with a high-temperature water resistant adhesive, e.g. marine epoxy, that may allow the point of continuity between the wire and the conductive electrode to remain dry, even if the assembly is immersed.

In still another set of embodiments, the electrodes comprise porous materials. Such electrodes may have higher surface areas for electron transport, and/or such electrodes may provide suitable channels for mass and energy flow through the electrodes, e.g., to avoid trapping gases such as H₂ or CO₂. The average porosity of the materials may be for instance, between about 100 micrometers and about 10 mm, less than about 10 mm, less than about 1 mm, etc. The average pore size may be determined, for example, from density measurements, from optical and/or electron microscopy images, or from porosimetry, e.g., by the intrusion of a non-wetting liquid (often mercury) at high pressure into the material, and is usually taken as the number average size of the pores present in the material. Such techniques for determining porosity of a sample are known to those of ordinary skill in the art. For example, porosimetry measurements can be used to determine the average pore size based on the pressure needed to force liquid into the pores of the sample. A non-limiting example of a porous material is a laminate sheet of an inert material (for example, carbon fiber, woven titanium), e.g., formed as a mesh, or a plurality of meshes. For instance, the spacing of one, or more than one of the meshes may be between about 100 micrometers and about 10 mm, less than about 10 mm, less than about 1 mm, etc.

In some embodiments, the electrode comprises graphite. Non-limiting examples of such electrodes include graphite cloth, carbon fiber cloth, graphite paper, a graphite-containing coating, a graphite-containing paint, or a graphite-containing powder. Graphite may be useful, for example, as a conductive non-metallic material; in some cases, metal electrodes may cause the release of metal ions, which may be toxic to the microorganisms at relatively high concentrations. The electrode may be formed from graphite (e.g., a graphite plate or a graphite rod), or formed from other materials to which graphite is added and/or upon which the graphite is adhered.

The following examples are intended to illustrate certain embodiments of the present invention, but do not exemplify the full scope of the invention.

### Example 1

In this example, to test the influence of oxygen on power production, two and three-chamber MFCs (microbial fuel cells) were fabricated. In brief, two chamber MFCs with two reactors, 250 mL reagent bottles modified to include a gas-tight o-ring seal on the cap and a glass tube with o-ring flange along the side. The reactors were coupled to one another, separated by a 4 cm² nafion-119 membrane (secured between two viton o-rings). Both reactors were fitted with two sections of ⅛ inch PEEK tubing (1 inch=2.54 cm) to enable gas flow into and out of the reactor. One reactor—termed the anode compartment—hosted a 1 cm×1 cm×8 cm length of grade 2 graphite attached to a 24 ga (US) PVC-coated wire (the termination was potted in marine-grade epoxy to prevent corrosion). The other reactor—termed the cathode compartment—hosted a 2.5 cm×9 cm length of grade 2 graphite attached to 24 ga (US) wire as described above. In addition, the cathode compartment hosted a silver-silver chloride reference electrode (Microelectrodes, Inc). All throughputs into and out of the chamber caps were potted with marine grade epoxy to insure the reactors remained gastight.

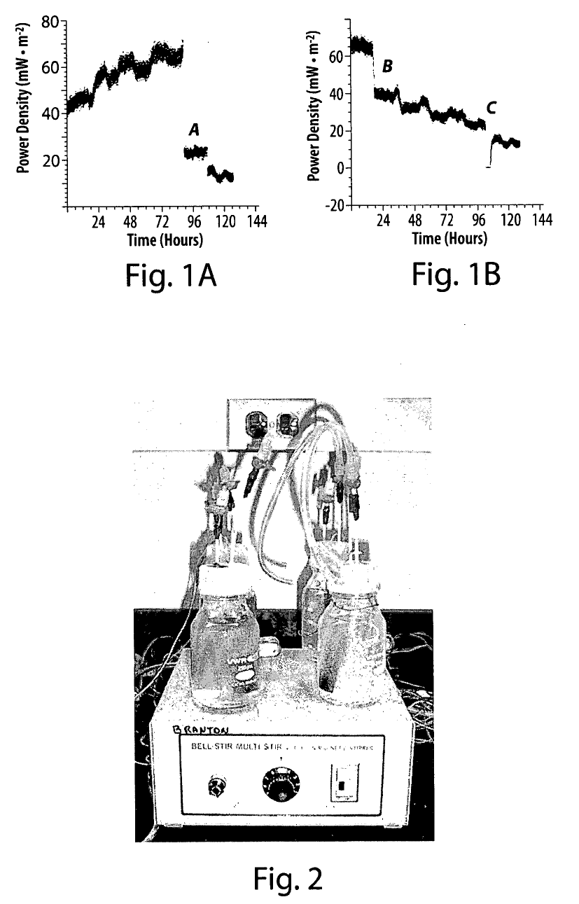

The three chamber MFCs employ the same anode and cathode compartment, but they were connected via a middle compartment, 100 mL in volume with two glass tubes on opposing sides, that can be filled with any relevant solution and sparged with any gas (FIG. 1B). This chamber did not contain an electrode.

To maintain gas control in both the anode and cathode compartments, high-performance mass flow controllers were used to deliver combinations of methane, nitrogen, or oxygen at rates between 0.05 and 500 cm³/min (±0.5%, Sierra Instruments Inc). To prevent desiccation within the reactor volumes, all gases were passed through a hydration flask filled with 0.2 micron filter sterilized distilled water, prior to entering the reactors.

In addition, each reactor cap was fitted with a gastight chromatography septum to allow fluid samples to be taken during the course of the experiment (using glass syringe and a sideport needle). To insure sufficient mixing, each chamber contained a 0.5 cm Teflon coated stir bar. All chambers were stirred constantly at 100 rpm and maintained at 25±2° C. for the duration of the experiment.

To test the efficacy of methanotrophs in power production, Methylomonas methanica were acquired and cultured from Whittenbury and Krieg (American Type Culture Collection #51626) in 1 liter flasks containing filter-sterilized nitrate mineral salts media (#1306; ATCC), as well as on carbon-free agar plates. In both cases, a 1:1 mix of methane and air was provided to the headspace or plate incubator as the sole carbon source. For these experiments, M. methanica from liquid culture having achieved an optical density of 0.95 to were used as inoculum.

To test the ability of methanotrophs to contribute to power production, three treatments were designed to examine A) power production by methanotrophs provided with methane and variable oxygen concentration (including no oxygen), B) power production in relation to total methane concentration, and C) microbial density and distribution on the anode and in the media. In addition, to minimize variability in power production that may arise from changes in potential between anode and cathode, a potentiostat was used to maintain the potential at 150 mV for all treatments.

To examine power production with respect to methane and oxygen availability, both the cathode and anode compartments of the MFC were filled with 200 mL of 0.2 micron filter-sterilized methanotrophic media #1306. The cathode compartment was bubbled with 0.01 micron filter sterilized air, and was sealed to avoid contamination. This enabled the elimination of the contribution of any cathode-hosted microbial community to power production. Next, the anode compartment was then inoculated with 1 mL of M. methanica culture described above and bubbled with a mixture of 0.01 micron filter-sterilized methane and air at a flow rate of 10 ml/min for methane and 1 ml/min for air. This ratio was maintained until power production was observed. The reactor was maintained at this condition set for eighty hours (data not shown). The flow of methane was then incrementally increased to 20 ml/min over a period of twenty-four hours.

To test the influence of increased methane availability on power production, the methane flow to the reactor was titrated by varying the flow of methane from 20 ml/min to 30, 25, 35, 25, 45, and 35 ml/min respectively (while oxygen was maintained at 1 ml/min; FIG. 1A). The reactor was maintained at each of these states for approximately twelve hours. To test the rate at which power production would decline with reduced methane, the flow of methane was reduced to 5 and 1 ml/min respectively (FIG. 1A).

To test the effect of eliminating oxygen from the anode compartment, methane and oxygen was bubbled into the anode compartment at 35 ml/min and 1 ml/min respectively (FIG. 1B). Next, oxygen flow was dropped to 0.5 ml/min, 0.25 ml/min, 0.1 ml/min over a period of 76 hours. Then, nitrogen was bubbled into the anode compartment for five hours, which quickly reduced the oxygen concentration to below the limits of detection (0.01 mg/L oxygen (or 312 nmol/L) and led to a cessation of power production (FIG. 1B). Afterwards, the reactor was returned to a methane to air mixture, power was restored.

FIG. 1 shows the relationship between increasing methane concentration in the reactor and power production (shown on the Y axis). These data demonstrate the coupling of methane to power production, as there is a near correspondence between methane availability and power density. At the point labeled “C”, methane was eliminated from the system and introduced nitrogen instead, which resulted in a total cessation of power production. This power production was restored upon the re-introduction of methane.

FIG. 2 shows the two bottle methane bioreactor. The left reactor is the Methylomonas culture. The chambers were separated by a nation membrane, which allowed hydrogen ions to pass but reduces the exchange of other ions.

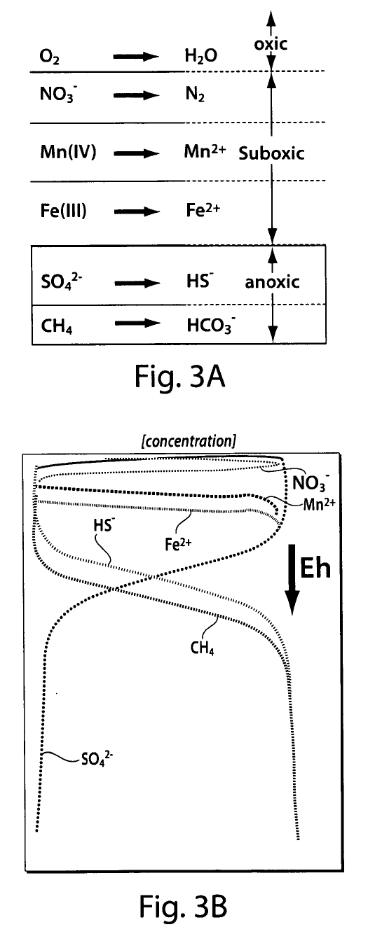

Deposition of organic carbon and its subsequent metabolism by microbes yield a typically predictable stratification of chemical composition and oxidation potential (Eh; as shown in FIG. 3). Favorable oxidants are used first, less favorable oxidants follow. MFCs can harness energy from sedimentary carbon by providing microbes with a terminal electron acceptor, directly or indirectly. However, no system exists that favors the production of energy from methane.

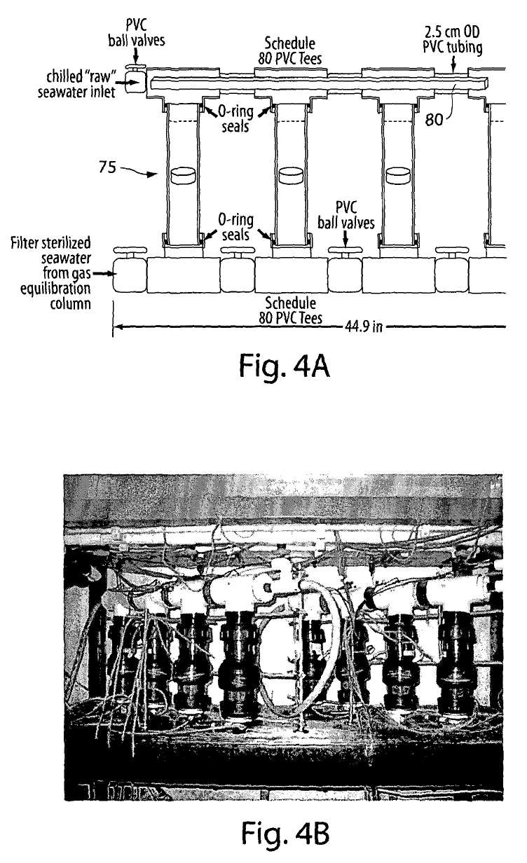

The anaerobic methane MFC shown in the example of FIG. 4 is a two-stage reactor system that is designed to enable methane flux into the sediment via adjective porewater flow, while maintaining a separation of anode and cathode compartments. The design of this adjective flow reactor is sketched out below.

In FIG. 4A, the anodes 75 are shown as grey discs, residing within the sediment (or in an industrial setting, a packed bead column). The cathode is the long rod at the top 80, which is flushed with aerated water. The parallel nature of this reactor design allows mass scaling without encountering the limits seen in larger, monolithic applications. FIG. 4B shows the implementation of the anaerobic methane MFC reactors.

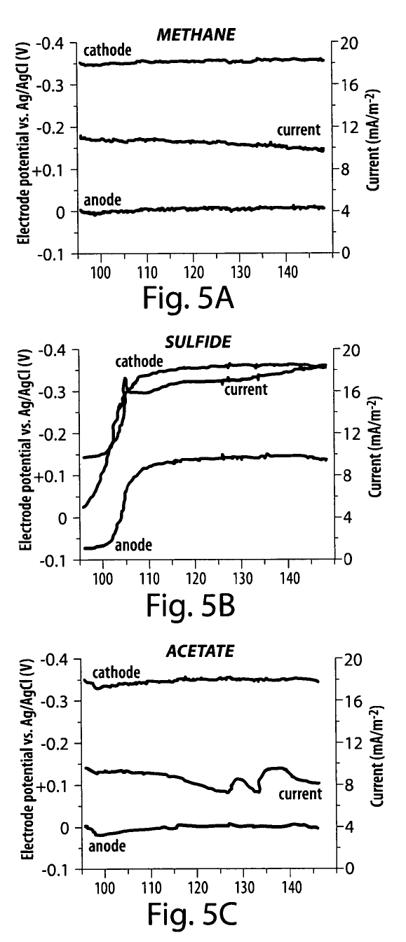

The power density of the reactor is shown in FIG. 5 as a comparison to the other reduced organics potentially available at hydrocarbon seeps, including sulfide and acetate. These data show that power production from methane approaches that of power production of the refined fuel acetate, when supplied to sediment-hosted MFCs. These data are best seen in the Table 1, which normalized power production to the concentration of the metabolite (methane, sulfide and acetate).

TABLE 1

| | Source | Period of | Average | |
|---|---|---|---|---|
| | Metabolite | sustained | Current | Normalized |
| | Concentration | current | density | current density |
| System | (mM) | (Exp. Day) | (mA/m²) | (A/m² · M) |
| Acetate | 1.0 | 95-147 | 8.8 ± 0.7 | 8.8 |
| Methane | 1.5 | 96-148 | 10.5 ± 0.3 | 7.0 |
| Sulfide | 8.1 | 110-148 | 17.3 ± 0.6 | 2.1 |

In addition, in some experiments, the anaerobic methane MFC promoted the growth of uncultured archaea that are believed to be involved in anaerobic methane oxidation in situ, namely the ANME-3 group. Again, these microbes have yet to be recovered in culture, but are able to be grown in this reactor. The phylogenetic tree shown in FIG. 9 indicates which of the archaea were cultured in this reactor (the most important ones are highlighted).

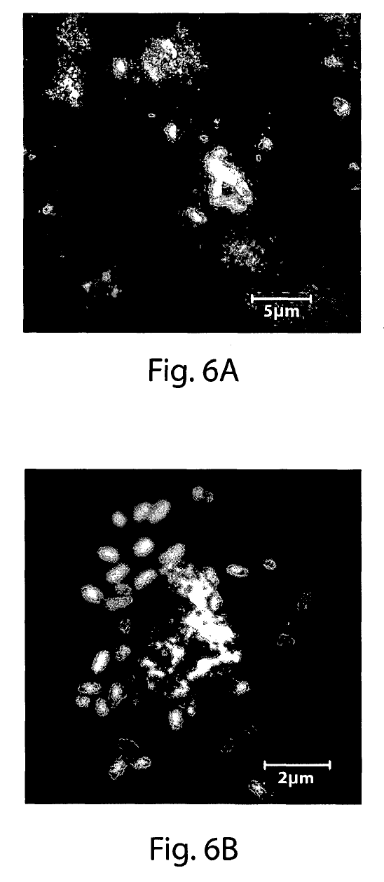

Analyses further indicates that a syntrophic association between the newly cultured ANME-3 and a bacteria, desulfobulbus proprionicus, may be responsible for power production in these methane-fed fuel cells. The images in FIG. 6 show a syntrophic coupling between these, which was encouraged by the conditions within the reactor. FIG. 6A show a fluorescent in situ hybridization micrograph of the ANME-3 in association with the desulfobulbus proprionicus. To verify the accuracy of this micrograph, the analyses was repeated with different probes and dyes, and revealed the same pattern (shown in FIG. 6B, with ANME-3 methane oxidizing archaea, and the syntrophic bacteria)

The data suggest that models such as those shown in FIG. 7 are responsible for anaerobic methane power production.

In conclusion, methane is ubiquitous in the biosphere. There are 90 gigatons of methane in terrestrial ecosystems, and 90 gigatons of methane on marine ecosystems. Much of this methane is of little use in power production, e.g., due to cost of capturing and shipping methane. Methane MFCs such as those described in this example offer an opportunity to recover energy from methane without combustion, and without the expense incurred in compressing and transporting the gas.

Research has focused on MFCs that use soluble fuels, and few studies have examined the use of volatiles in fueling MFCs. Methane is an abundant, highly reduced but chemically stable compound that is present to varying degrees in natural and industrial settings. There has been research on methane oxidation, both aerobic and anaerobic, with an emphasis on understanding the biochemical mechanisms underlying this process, and determining its significance in natural methane cycling. Methane is unique because of its chemical stability at STP (for instance, it cannot readily be abiotically oxidized at environmental conditions).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1-79. (canceled)

80. A fuel cell comprising:
an anode comprising a current collector and methanotrophs in an oxygen controlled environment;
a cathode; and
a methane source to provide methane.

81. The fuel cell of claim 80, wherein at least some of the methanotrophs are aerobic.

82. The fuel cell of claim 80, wherein at least some of the methanotrophs are anaerobic.

83. The fuel cell of claim 80, wherein at least one of the methanotrophs is Methylomonas methanica.

84. The fuel cell of claim 80, wherein the methane source is a purified methane gas;
chemical or industrial reactions; a biomass comprising plant material, animal material, oil, petroleum, or coal; or a mixture of any two or more thereof.

85. The fuel cell of claim 80, wherein the oxygen controlled environment is an oxygen deficient or an anaerobic environment.

86. The fuel cell of claim 80, wherein the methanotrophs are configured to oxidize the methane to produce electrons; and the current collector is configured to collect some or all the electrons.

87. The fuel cell of claim 86, wherein the current collector comprises a non-conductive material and a conductive coating at least partially surrounding the non-conductive material.

88. The fuel cell of claim 80, wherein the fuel cell is configured to produce power of at least about 1 W/m² of anode surface.

89. The fuel cell of claim 80, wherein the anode and the cathode are separated by a proton exchange interface.

90. The fuel cell of claim 89, wherein the proton exchange interface is a packed bead column.

91. A method, comprising:
providing a fuel cell comprising sediment, the sediment comprising methanotrophs;
passing a solution comprising water and methane through the sediment at a rate sufficient for the methanotrophs to oxidize the methane and produce a current; and
collecting the current.

92. The method of claim 91, wherein the sediment is a terrestrial or marine sediment.

93. A fuel cell comprising:
a first compartment comprising an anode and methanotrophs; and
a second compartment comprising a cathode;
wherein:
the methanotrophs oxidize methane delivered to the fuel cell to produce electrons that are accepted by the anode.

94. The fuel cell of claim 93, wherein at least some of the methanotrophs are aerobic.

95. The fuel cell of claim 93, wherein at least some of the methanotrophs are anaerobic.

96. The fuel cell of claim 93, wherein at least one of the methanotrophs is Methylomonas methanica.

97. The fuel cell of claim 93, wherein the first and second compartments are separated by a proton exchange interface.

98. The fuel cell of claim 97, wherein proton exchange interface preferentially allows hydrogen ion transport relative to non-hydrogen ions.

99. The fuel cell of claim 97, wherein the proton exchange interface is a polymeric interface.

100. The fuel cell of claim 99, wherein the proton exchange interface is non-polymeric.

101. The fuel cell of claim 100, wherein the proton exchange interface comprises particles having an average diameter of less than about 500 micrometers.

102. The fuel cell of claim 101, wherein the interface further comprises a first mesh screen and a second mesh screen containing the particles therebetween.

103. The fuel cell of claim 101, wherein the proton exchange interface is non-integral.

104. The fuel cell of claim 101, wherein the proton exchange interface is a packed bed.
